(19) United States
(12) Patent Application Publication
(10) Pub. No.: US 2005/0223372 A1
(43) Pub. Date: Oct. 6, 2005

(54) Methods and systems for firmware download configuration

(76) Inventor: Gregory E. Borchers, Vancouver, WA (US)

Correspondence Address: CHERNOFF, VILHAUER, MCCLUNG & STENZEL, LLP, 1600 ODS TOWER, 601 SW SECOND AVENUE, PORTLAND, OR, 97204, US

(21) Appl. No.: 10/816,575

(22) Filed: Apr. 1, 2004

(51) Int. Cl. G06F 9/44

(52) U.S. Cl. 717/168

(57) ABSTRACT

Embodiments of the present invention comprise systems and methods for preservation of configuration data during firmware upgrades.

### BACKGROUND OF THE INVENTION

Printers, copiers, scanners, digital cameras, and a myriad of other digital devices contain firmware that stores logical instructions that may be executed by processors. Periodically, this firmware can be updated and modified to provide enhanced functionality and improved performance. Generally, firmware is configured by a user to provide custom functions suited to a particular user or usage. These configuration options are typically stored in memory along with the executable instructions of the firmware. Configuration data is commonly stored monolithically within the firmware download file where it is difficult to separate from the executable instructions.

If configuration and option data are not extracted from the firmware instructions prior to a firmware upgrade, the configuration and option data may be lost during the upgrade process. This will necessitate reconfiguration of the firmware which can be a tedious and difficult process particularly when the device has a limited user interface or awkward input device as is the case of many smaller digital devices.

In many cases firmware upgrade is accomplished by establishing a serial connection between a firmware-containing device and a host computer used for the upgrade. The host computer will contain a firmware download utility and a firmware upgrade file. The firmware upgrade file is sent across the serial connection to the device where it overwrites the existing firmware file including any configuration data. During the firmware download process the device is not generally available for use.

### BRIEF SUMMARY OF THE INVENTION

Methods and Systems of embodiments of the present invention comprise a web-based printer administration utility that manages firmware configuration data during the firmware download process. Some of these embodiments employ logic to determine what data is to be preserved and where that data should be preserved. After the download process is accomplished or during the process, some embodiments will restore the configuration data. Some embodiments may also maintain a download or upgrade history as metadata or in some other format.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a flow chart showing firmware configuration restoration methods of some embodiments of the present invention;

FIG. 2 is a diagram showing the connections to a typical device during firmware upgrade using the methods of embodiments of the present invention;

FIG. 3 is a flow chart describing firmware upgrade methods comprising firmware configuration data conversion;

FIG. 4 is a flow chart describing firmware upgrade methods comprising firmware configuration data conversion and re-combination prior to firmware installation; and

FIG. 5 is a flow chart describing firmware upgrade methods comprising a network query.

### DETAILED DESCRIPTION OF PREFERRED EMBODIMENTS

Embodiments of the present invention comprise systems and methods for modifying, upgrading, downloading and otherwise changing firmware executables and data without the necessity of repeating manual input of configuration data after the download process.

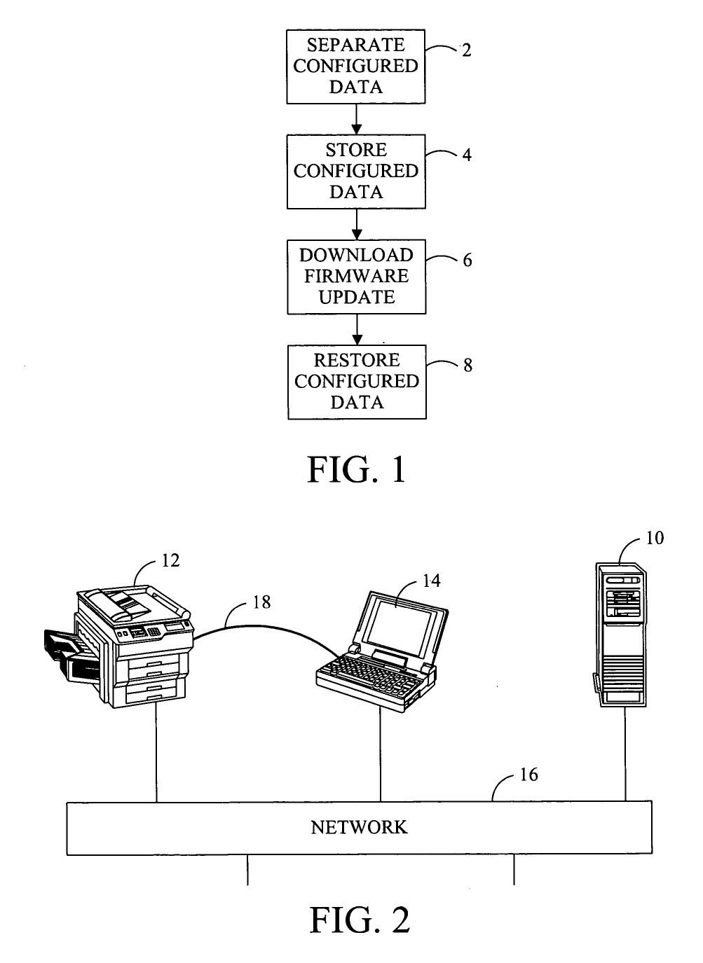

In some embodiments of the present invention, illustrated in FIG. 1, configuration data is separated 2 from the executable firmware image by executing a process that stores 4 the configuration data to a device management utility before the firmware upgrade 6. Configuration data may be extracted from specific memory locations on a device or the entire memory may be downloaded. If more information than the configuration data is extracted, the data may be separated by parsing or by other known methods. Configuration data may be stored on the device being upgraded or on some other storage device in communication with the upgraded device. Once the configuration data has been stored, the firmware upgrade may be accomplished 6. The configuration data is then retrieved 8 from the device management tool after the firmware upgrade.

Some embodiments of the present invention, as illustrated in FIG. 2, comprise a web-based printer administration utility that may be executed on a web server 10 to which a firmware-upgradeable device 12 is connected. A firmware-upgradeable device 12 may be a printer, copier, multi-function peripheral (MFP), scanner, fax machine, or almost any other digital device. In some embodiments, a download computing device 14 is also used. The firmware-upgradeable device 12, the web server 10 and the download computing device 14 may be connected with a typical network connection 16, such as through a local area network (LAN). Network connection 16 may be accomplished using a typical wired network connection or through a wireless connection such as an IEEE 802.11(b) or (g) connection, a Bluetooth® connection, an infrared connection or by many other known connectivity methods. In some embodiments, a further download connection 18 is made between download computing device 14 and firmware-upgradeable device 12. This may be accomplished through a serial connection such as an RS232 link, an IEEE 1394 connection or by many other connectivity methods including those used for the network connection 16.

The firmware download process typically takes place over download connection 18 between download computing device 14 and the firmware-upgradeable device 12. This process may be made aware of the web-based download management tool on web server 10 during the firmware download process. The download process may trigger a user interface comprising a menu structure or some other interface for selecting configuration preservation options. The firmware download process may utilize methods of the present invention to enhance the download process by managing the configuration data in the device 12 that is typically lost during firmware download.

The combination of a web-based data management utility connected via a network 16 and the download computing device 14 connected via direct link 18 to device 12 allows flexibility beyond known download methods. The device management web server 10 manages device 12 configuration and settings data during the firmware download process. In this manner configuration data may be extracted and stored and then restored to the new firmware structure during and after the download process.

Using embodiments of the present invention, device 12 firmware memory may be completely erased while the previous configuration and settings data is preserved in a central server accessible by the upgradeable device 12 and the download computing device 14.

In some embodiments of the present invention, pre-download configuration and settings data are extracted and stored. This configuration data may then be converted to updated configuration data that is compatible with the new firmware upgrade. For example, when new functionality is added in the firmware upgrade that requires configuration data in a new format, embodiments of the present invention may extract the old data, convert it to a new format and restore the new configuration to the upgraded firmware.

Some embodiments may also query network elements to ascertain configuration data needed by a new firmware upgrade. When new functionality is added that requires information about peripherals on the network or the type and configuration of the network itself, a web-based management utility may query network components to obtain this data and configure the new firmware functions to interface properly with the network configuration.

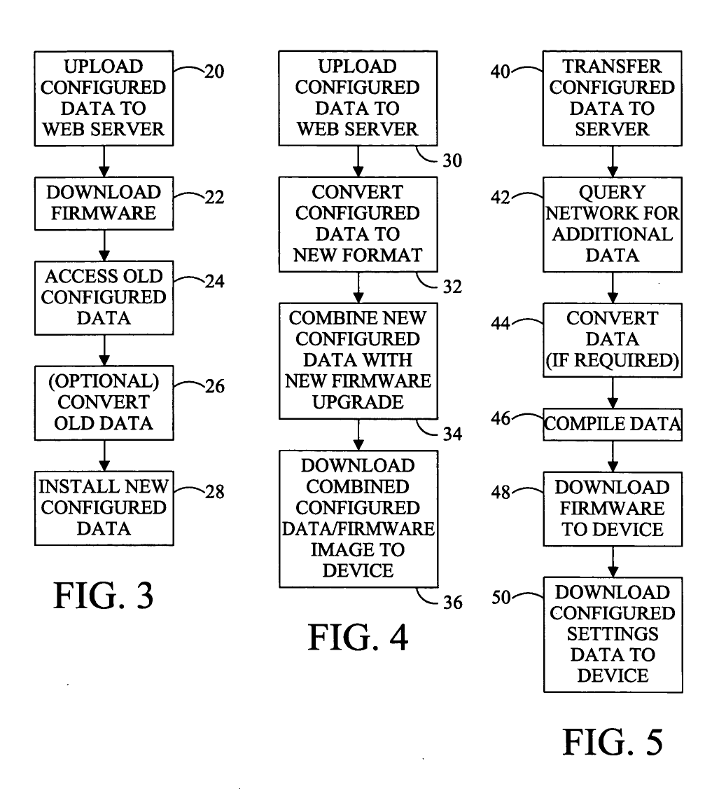

Some embodiments of the present invention, illustrated in FIG. 3, may employ a web-browser-based device administration utility (DAU) as a repository for device configuration and settings data. Configuration and settings data is uploaded 20 to the device management utility web server 10. Configuration upload may be accomplished using Simple Network Management Protocol (SNMP) methods, Hypertext Transfer Protocol (HTTP) methods or by other methods. The firmware update is then initiated at the upgradeable device 12 or at the download computing device 14. When the download 22 is complete, the web browser utility is invoked and the web server is accessed 24 to retrieve the configuration data. At this point, the old configuration data may be converted 26 to be compatible with the new firmware. Once any conversion has taken place, the new configuration data may be installed 28 in the new firmware. New configuration data installation may be accomplished using SNMP, HTTP or other protocols to restore settings to the upgradeable device 12.

Some embodiments of the present invention may be described with reference to FIGS. 4 and 2. In these embodiments, device configuration and settings data may be uploaded 30 to a web server 10 before firmware modifications. Once this data is uploaded, the data may be converted 32 to a format that will be compatible with the new firmware upgrade. When the configuration data format remains unchanged, this step may be omitted. Once the configuration data is in a format compatible with the new installation, the configuration data may be merged or otherwise combined 34 with the firmware upgrade. This process may form a complete image that may be used to entirely replace the existing firmware structure. This image may then be downloaded 36 to the device 12 where it will replace the prior firmware structure.

In some embodiments of the present invention, as described with reference to FIGS. 5 and 2, a device's configuration data may be transferred 40 to a server 10 over a network connection 16. Once configuration data is transferred, device memory may be completely erased if necessary. When a firmware upgrade adds new functionality to a device, often additional configuration data will be required. In some embodiments, this additional configuration data may be obtained automatically through a web server 10, which is capable of querying network devices and components for data related to the firmware-upgradeable device 12 and/or other network devices and components. Once sufficient data has been retrieved and determined this data may be converted 44 to a format compatible with the new firmware upgrade. In some embodiments, this last step may not be necessary.

Data from all sources may then be compiled 46 into a configuration data structure that may be combined with the firmware before download or integrated into the firmware after download. In either case, the firmware is downloaded 48 into the upgradeable device 12 and the configuration data is also downloaded 50 either as a part of the new firmware or separately in a distinct operation.

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

1. A method for preserving configuration data during firmware modification, said method comprising:
a) extracting configuration data from an existing firmware structure in a firmware device;
b) storing said configuration data;
c) downloading a new firmware structure to said device; and
d) restoring said configuration data to said new firmware structure in said firmware device.

2. A method as described in claim 1 wherein said storing takes place on a web server.

3. A method as described in claim 1 wherein said downloading is accomplished via a link between a download computing device and said firmware device.

4. A method for preserving configuration data during firmware modification, said method comprising:
a) extracting configuration data from an existing firmware structure in a firmware device wherein said extracting is accomplished over a network connection;
b) storing said configuration data on a web server;
c) downloading a new firmware structure from a download computing device to said firmware device, wherein said downloading is accomplished via a direct connection; and
d) restoring said configuration data to said new firmware structure in said device.

5. A method as described in claim 4 wherein said direct link is a serial link.

6. A method as described in claim 4 wherein said restoring also comprises installing additional configuration data

7. A method for preserving configuration data during firmware modification, said method comprising:
a) uploading configuration data from an existing firmware structure in a firmware device wherein said uploading is accomplished over a network connection;
b) storing said configuration data;
c) downloading a new firmware structure from a download computing device to said firmware device thereby replacing said existing firmware structure;
d) converting said configuration data to a format compatible with said new firmware structure and
e) installing said converted configuration data to said new firmware structure in said device.

8. A method as described in claim 7 wherein said storing is accomplished on a web server.

9. A method as described in claim 7 wherein said storing is accomplished on a download computing device.

10. A method as described in claim 7 wherein said storing is accomplished on said firmware device.

11. A method as described in claim 7 wherein said downloading is accomplished over a serial link.

12. A method as described in claim 7 wherein said downloading and said installing are accomplished in a single step.

13. A system for preserving configuration data during firmware modification, said method comprising:
a) a firmware device comprising an upgradable firmware structure and configuration data;
b) a web-based data management utility residing on a server;
c) a download computing device;
d) a network connection connecting said firmware device, said download computing device and said web-based management utility; and
e) a direct connection between said firmware device and said download computing device, wherein said management utility may recover said configuration data from said firmware device and store said configuration data on said server while said firmware structure is upgraded to a new firmware structure and wherein said configuration data may be installed to said new firmware structure after upgrading thereby preserving said configuration data.

14. A system as described in claim 13 wherein said configuration data is converted to a new format before installation on said new firmware structure.

15. A system as described in claim 13 wherein said configuration data is compiled with additional configuration information before installation on said new firmware structure.

16. A system as described in claim 15 wherein said additional configuration information is obtained by querying network devices.
